(19) United States
(12) Patent Application Publication
(10) Pub. No.: US 2017/0289665 A1
(43) Pub. Date: Oct. 5, 2017

(54) Flexible Conformal Cushioned Headphones

(71) Applicant: Nikola Taisha Naylor-Warren, Arnold, PA (US)

(72) Inventor: Nikola Taisha Naylor-Warren, Arnold, PA (US)

(21) Appl. No.: 15/279,633

(22) Filed: Sep. 29, 2016

Related U.S. Application Data
(60) Provisional application No. 62/390,616, filed on Apr. 4, 2016.

(51) Int. Cl. H04R 1/10

(52) U.S. Cl. CPC H04R 1/105; H04R 1/1066

(57) ABSTRACT

Headphones designed for comfort have a flexible, deformable armature which supports speakers. An elastic strip attached to the armature biases it into a curved shape. The armature and speakers are surrounded by a fabric sheath. A layer of flexible, resilient material such as polyester foam is interposed between the armature and the sheath for cushioning. The speakers are held in pockets positioned in the sheath at opposite ends of the armature.

### CROSS REFERENCE TO RELATED APPLICATION

This application is based upon and claims priority to U.S. Provisional Application No. 62/390,616 filed Apr. 4, 2016 and hereby incorporated by reference herein.

### FIELD OF THE INVENTION

This invention relates to headphones for converting electrical signals to sounds.

### BACKGROUND

Headphones used to convert electrical signals into sounds find widespread use, for example, for private listening to music, news and the like. When used in conjunction with a microphone headphones permit two way communication, for example, using cellular telephones.

Headphones are intended to be worn on the head of the user and for them to be truly “hands free” must reliably maintain their position. Comfort is also a factor, especially if headphones are to be worn for extended periods. Furthermore, the headphones should be adjustable to securely fit a wide range of head sizes and shapes as well as a wide variety of wearing styles. For example, many individuals use headphones to induce sleep, and thus it is important for headphones to be comfortable and maintain their position on the head of the wearer when the wearer is lying down with their head on a pillow. The design choices found in prior art headphones are a compromise which favor some requirements, for example, characteristics that help the headphones maintain their position, over other requirements, such as comfort and adjustability. There is clearly a need for headphones having characteristics which strike a more balanced design for the considerations of adjustability and comfort.

### SUMMARY

The invention concerns headphones. In one example embodiment the headphones comprise an elongate, flexible, deformable armature. An elastic strip is attached lengthwise along the armature. At least a first speaker is supported by the armature. In a specific example embodiment the armature comprises a deformable metal core. By way of further example a sheath surrounds the armature. The sheath comprises a flexible substrate. The substrate may comprise a fabric. A layer of resilient, flexible material may be positioned between the sheath and the armature. By way of example the resilient, flexible material comprises polymer foam.

In an example embodiment the first speaker comprises a wireless receiver and a power source. A further example embodiment comprises a second speaker supported by the armature. Another example embodiment comprises an electrical connector. First and second electrical conductors connect the first and second speakers to the electrical connector.

In a particular example embodiment the armature has first and second ends oppositely disposed. The first speaker is supported by the armature at the first end thereof and the second speaker is supported at the second end thereof. By way of further example the armature forms respective first and second loops at the first and second ends. In an example embodiment, first and second pockets are formed in the sheath. The first and second pockets are respectively positioned adjacent to the first and second ends of the armature. The first speaker is received in the first pocket, the second speaker is received in the second pocket in this embodiment.

The invention further encompasses headphones for supporting a speaker comprising, by way of example, an elongate, flexible, deformable armature. An elastic strip is attached lengthwise along the armature. A flexible sheath surrounds the armature. A specific example embodiment further comprises a layer of resilient, flexible material positioned between the sheath and the armature. In an example embodiment, a first speaker is supported by the armature. By way of example the first speaker is supported between a layer of resilient flexible material and the sheath. Another example embodiment comprises a second speaker supported by the armature. The first speaker is positioned at a first end of the armature; the second speaker is positioned at a second end of the armature in this example. By way of further example the armature forms respective first and second loops at respective first and second ends of the armature. Another embodiment comprises first and second pockets formed in the sheath. The first and second pockets are respectively positioned adjacent to respective first and second ends of the armature in an example embodiment.

### BRIEF DESCRIPTION OF THE DRAWINGS

FIG. 1 is a plan view of an example embodiment of headphones according to the invention;

FIG. 2 is a cross sectional plan view of the headphones shown in FIG. 1;

FIG. 3 is a cross sectional view taken at line 3-3 of FIG. 1; and

FIG. 4 is a cross sectional view taken at line 4-4 of FIG. 1.

### DETAILED DESCRIPTION

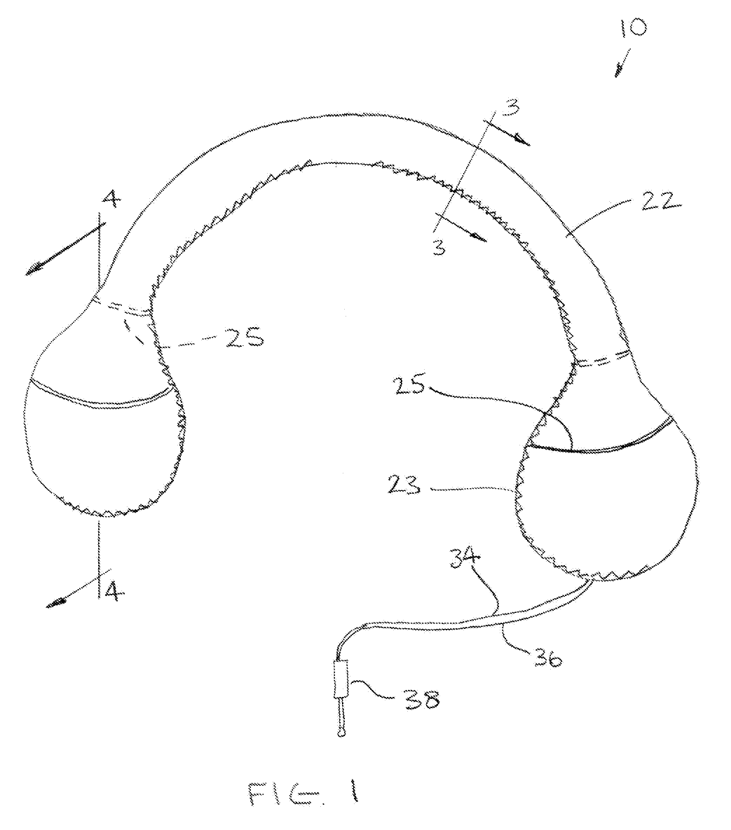

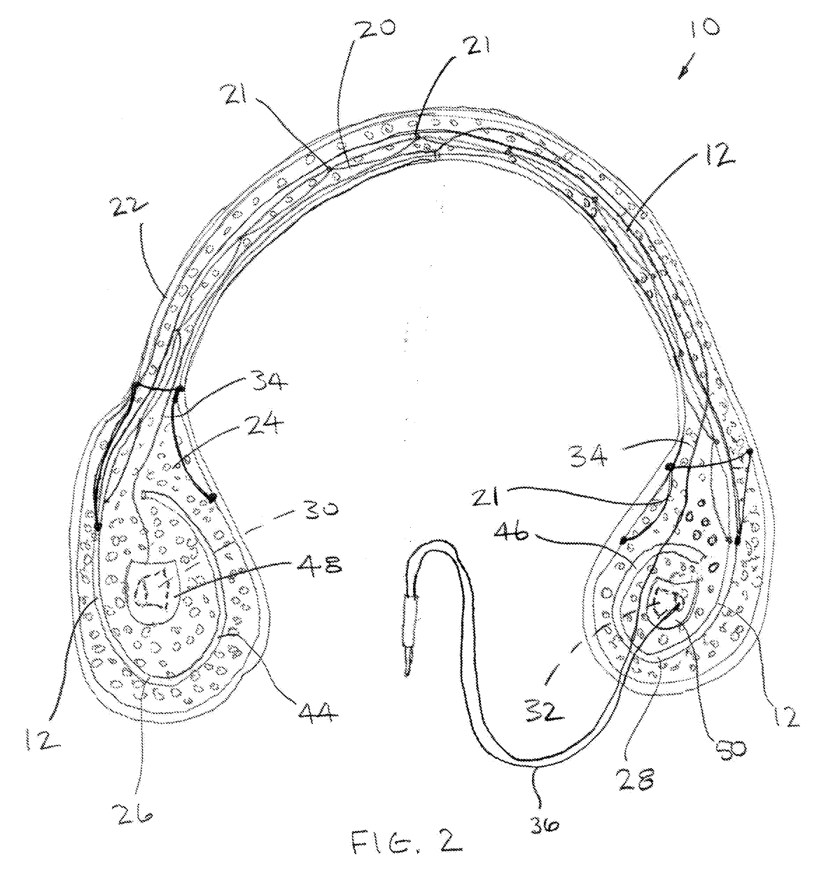

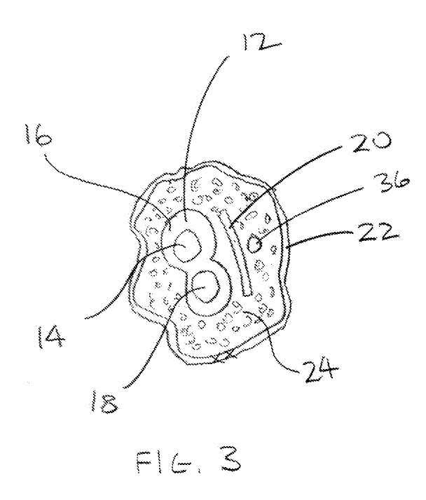

FIGS. 1 and 2 show an example embodiment of a set of flexible, conformal, cushioned headphones 10 according to the invention. As shown in cross section in FIG. 2, headphones 10 comprise an elongate, flexible, deformable armature 12. An example armature 12, as shown in FIG. 3, comprises a deformable metal core 14 surrounded by a flexible sleeve 16. In a practical example the metal core 14 may comprise one or more copper wires 18, and the sleeve 16 may comprise a polymer insulating layer. Copper is advantageous because it readily deforms plastically without failing and can be deformed many times to adapt the headphones to a desired shape. As shown in FIG. 2, an elastic strip 20 is attached lengthwise along the armature 12. Elastic strip 20 may comprise woven elastic yarns attached, either continuously to or at a plurality of points 21, along the length of the armature 12. Elastic strip 20 applies a compression force to the armature 12 to bias it into a curved configuration. The armature 12 remains flexible however, and can deform to conform comfortably to the shape a wearer's head, the elastic strip 20 providing the biasing force so that the headphones remain securely in place on the wearer's head. The elastic strip 20 may be attached to the armature 12 by stitching, cinching, heat fusing, and adhesives to cite a few examples. U-shaped elastic anchors 21 are attached between armature 12 and a flexible sheath 22 which surrounds the armature. The U-shaped anchors are also formed of an elastic strip and provide guidance determining how the headphones 10 conform to the ears of a wearer.

As shown in FIGS. 1-3, flexible sheath 22 surrounds the armature 12 and its elastic strip 20. Sheath 22 comprises a flexible substrate, for example, a fabric such as felt, or woven or knitted fabrics of cotton, wool or polyester, as well as blends of synthetic and natural fibers. It is advantageous that the sheath 22 be formed of a material which is comfortable to wear against the skin. The fabric forming the sheath 22 may be stitched together, as shown at 23, to form a desired shape as shown in FIG. 1. Openings 25 may be located at various positions in the sheath 22 to provide access to the interior of the headphones 10. The openings in this example embodiment comprise flaps secured in a closed position by hook and loop fasteners and permit insertion and adjustment of internal components, such as speakers and wires described below.

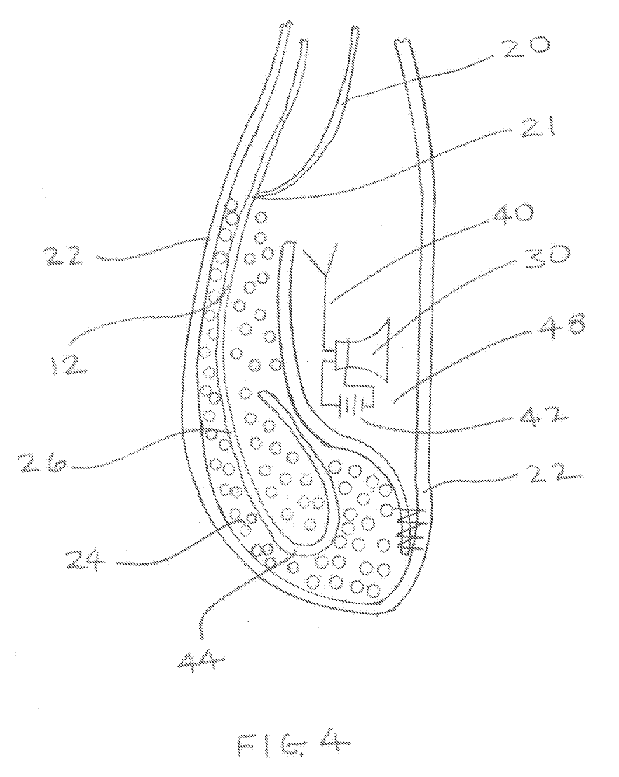

As shown in FIGS. 2 and 4, a layer of resilient, flexible material 24 is positioned between the sheath 22 and the armature 12. Material 24 serves a cushioning function and is advantageously formed of a polymer foam. Material 24 may extend along the entire length of armature 12 as shown in FIGS. 2 and 3 or be confined to regions at the first and second ends 26 and 28 of the armature 12 as shown in FIG. 4 (first end 26 shown).

As shown in FIG. 2, armature 12 supports first and second speakers 30 and 32. In one example embodiment, speakers 30 and 32 further comprise electrical conductors 34, 36, (wires) which connect the speakers 30 and 32 to an electrical connector 38, such as a plug engageable with a standard audio jack. FIG. 4 shows a wireless embodiment, wherein the speakers 30 and 32 (30 shown) comprise a radio frequency receiver 40 and a power source powering the speakers, such as a battery 42. It is anticipated that this embodiment will allow compatibility with Bluetooth wireless technology standards.

As shown in FIG. 2, speakers 30 and 32 are supported by the armature 12 at its opposite ends 26 and 28. To enhance the support function the ends 26 and 28 of armature 12 may be formed into respective first and second loops 44 and 46. The flexible, resilient layer 24 surrounds the loops 44 and 46 to provide cushioning to the wearer when lying down on the headphones 10. To ensure that the speakers 30 and 32 remain at fixed positions within the sheath 22 so that they can be reliably located adjacent to a wearer's ears, the speakers are received within respective first and second pockets 48 and 50. As shown in FIG. 4, pockets 48 and 50 (48 shown) are formed in sheath 22 adjacent to respective loops 44 and 46. To maximize audio transmission the speakers 30 and 32 are positioned between the layer of flexible resilient material 24 and the sheath 22. Hook and loop fasteners may be used to secure pockets 48 and 50 closed, as well as to provide a secure closure to seams in the sheath 22 which, when open, provide access to the interior of the headphones for the placement of speakers or other components.

It is expected that headphones such as example embodiment 10 according to the invention will provide improved comfort to the wearers while still maintaining position securely on the wearer's head even when in contact with pillows or other surfaces.

What is claimed is:

1. Headphones, said headphones comprising:
an elongate, flexible, deformable armature;
an elastic strip attached lengthwise along said armature;
at least a first speaker supported by said armature.

2. The headphones according to claim 1, wherein said armature comprises a deformable metal core.

3. The headphones according to claim 1, further comprising a sheath surrounding said armature.

4. The headphones according to claim 3, wherein said sheath comprises a flexible substrate.

5. The headphones according to claim 4, wherein said substrate comprises a fabric.

6. The headphones according to claim 3, further comprising a layer of resilient, flexible material positioned between said sheath and said armature.

7. The headphones according to claim 6, wherein said resilient, flexible material comprises a polymer foam.

8. The headphones according to claim 1, wherein said first speaker comprises a wireless receiver and a power source.

9. The headphones according to claim 3, further comprising a second speaker supported by said armature.

10. The headphones according to claim 9, further comprising:
an electrical connector;
first and second electrical conductors connecting said first and second speakers to said electrical connector.

11. The headphones according to claim 9 wherein said armature has first and second ends oppositely disposed, said first speaker being supported by said armature at said first end thereof and said second speaker being supported at said second end thereof.

12. The headphones according to claim 11, wherein said armature forms respective first and second loops at said first and second ends.

13. The headphones according to claim 11, further comprising first and second pockets formed in said sheath, said first and second pockets being respectively positioned adjacent to said first and second ends of said armature, said first speaker being received in said first pocket, said second speaker being received in said second pocket.

14. Headphones for supporting a speaker, said headphones comprising:
an elongate, flexible, deformable armature;
an elastic strip attached lengthwise along said armature;
a flexible sheath surrounding said armature.

15. The headphones according to claim 14, further comprising a layer of resilient, flexible material positioned between said sheath and said armature.

16. The headphones according to claim 14, further comprising a first speaker supported by said armature.

17. The headphones according to claim 16, wherein said first speaker is supported between a layer of resilient flexible material and said sheath.

18. The headphones according to claim 16, further comprising a second speaker supported by said armature, said first speaker being positioned at a first end of said armature, said second speaker being positioned at a second end of said armature.

19. The headphones according to claim 14, wherein said armature forms respective first and second loops at respective first and second ends of said armature.

20. The headphones according to claim 14, further comprising first and second pockets formed in said sheath, said first and second pockets being respectively positioned adjacent to respective first and second ends of said armature.
